(19) United States
(12) Patent Application Publication
(10) Pub. No.: US 2023/0353080 A1
(43) Pub. Date: Nov. 2, 2023

(54) PHOTOVOLTAIC PANEL AND FASTENING DEVICE FOR SUCH A PANEL

(71) Applicant: BEEM ENERGY, Nantes (FR)

(72) Inventors: Pierre-Emmanuel ROGER, Nantes (FR); Arthur KENZO DEBAIGUE, San Francisco, CA (US); Ralph FEGHALI, Nantes (FR)

(21) Appl. No.: 18/006,311

(22) PCT Filed: Jul. 27, 2021
(86) PCT No.: PCT/EP2021/070941

§ 371 Date: Jan. 20, 2023

(30) Foreign Application Priority Data
Jul. 27, 2020 (FR) 2007927

(51) Int. Cl. H02S 20/22

(52) U.S. Cl. CPC H02S 20/22

(57) ABSTRACT

The present invention relates to a photovoltaic panel (3) comprising:
at least one photovoltaic cell (7) suitable for converting solar energy into electricity;
an electrical connection configured to connect the panel (3) to an electrical facility;
a fastening device (30); characterized in that the fastening device (30) of the panel (3) comprises:
   a first part (310) that acts as a support and that is intended to be fastened to a surface;
   a second part (330) secured to the panel; the first and second parts (310 and 330) being intended to cooperate mechanically, according to a pivot connection, to fasten the panel (3) to a surface via the first part (310).

### DESCRIPTION

The present invention relates to the photovoltaic or solar panels, in particular to panel with a device to install and secure said photovoltaic panel at a desired location.

From year to year, the global warming is a growing concern, both for individuals and the industry, which leads to the development of alternative energies, such as the solar energy, to reduce the greenhouse gas emissions (such as carbon dioxide).

The solar energy has, inter alia, the advantage of being unlimited, ecological, with a strongly decreasing price in recent years, which makes it competitive against classical energy sources, such as oil, nuclear plants, etc., among which the solar energy is the alternative energy with the highest growth. In this case, we particularly focus on producing electric energy thanks to photovoltaic panels.

Photovoltaic panels are generally mounted on the roof or a wall of a building, in order to maximize the quantity of solar energy that they receive and optimize their electric power output.

Generally, a specialist is required to install a photovoltaic panel, who sets up an adequate mechanical structure, on which the photovoltaic panels are to be secured.

The set-up of such a structure by a specialist is generally costly, time-consuming, and is difficult for a layman or the end-user.

Thus, the applicant puts forward a photovoltaic panel that includes a simplified securing device, so that anyone wishing to set up photovoltaic panels at home or anywhere adequate can do it by themselves in an easy and secure manner.

Hence, the invention is a new kind of photovoltaic panel including:
at least one photovoltaic cell capable to convert the solar energy into electricity;
a securing device;
characterizes in that the securing device of said panel includes:
a first part used as a support and designed to be fixed to a surface;
a second part in conjunction with said panel;
wherein said first and second parts are designed to cooperate mechanically, according to a pivot link, to secure said panel to a surface.

The panel according to the invention has notably the advantage of being easy to mount:

you only have to secure the first part to a surface, then to position (or clip) the panel to the first part through the second part. This mechanical cooperation between the first and the second part requires no tool: hence, it is easier to set up said panel, because the installer can do it by hand. It is also less dangerous to secure it up high, since the securing part by a tool of the first part is separate from the securing part of the panel to a surface.

It should be noted that a surface is considered to be at least three fulcrums, on which the first part of the securing device is able to lie. In addition, the securing part, in particular its first part, may be secured to any surface, i.e. a wall, a roof or an object. It should be noted that said first part includes advantageously at least two fulcrums on said surface. For example, the fixing of said first part of the device is made through securing means, such as screws, bolts, etc.

According to a possible characteristic, said panel includes an electric connection designed to link said panel to an electrical installation, to an electrical appliance and/or to another photovoltaic panel.

According to another possible characteristic, when in mechanical connection, the first and second parts are designed so that said parts are locked in one another.

Said first and second part, when mounted or put together, are designed so that they cannot be separated without a specific intervention. However, the first and second parts may be rotatively moved from one another, for example thanks to a pivot link from the cooperation of male and female components.

According to another possible characteristic, the first and second parts respectively include first and second respectively male and/or female components designed to mechanically coperate.

It is the mechanical cooperation between the male and/or female components of the first and second parts that allows the formation of a pivot link between said parts.

According to another possible characteristic, each female component includes at least one recess to receive a male component, for example to receive the protrusion of a male component.

According to another possible characteristic, the second female components include at least one movable sub-component (such as a piece) designed, on one hand, to receive a male component and, on the other hand, to lock the position of the male component into the female component.

Thus, the sub-component or movable piece of a female component is designed to receive a male component, in particular its protrusion, and once in position, to prevent any removal of the male component from the female component.

According to another possible characteristic, the movable sub-component is designed to switch between at least two different positions, wherein a first position makes it possible to insert a male component into the female component, while the second position makes it possible to said sub-component to lock the male component into the second component.

According to another possible characteristic, said movable sub-component (or piece) is rotatively mounted thanks to an axis.

According to another possible characteristic, said movable sub-component (or piece) is rotatively mounted thanks to a slide.

According to another possible characteristic, the female component includes said movable piece, where there is a notch that is used as a reception recess.

According to another possible characteristic, the female component includes at least one support piece to which the movable sub-component is linked.

According to another possible characteristic, at least one male component is designed so that said panel can switch between two different angular positions relative to the first part, for example a position where the second part (hence the panel) is tilted relative to the first part (hence the surface), and another position where the first and second parts are substantially in two planes parallel to each other.

This configuration makes it possible to select a tilt angle of the panel relative to the surface, on which it is secured.

According to another possible characteristic, inserting the male components into the female components is made along two different directions that are orthogonal to each other.

According to another possible characteristic, said securing device includes disengagement features to remove the second part from the first part of said device.

The invention also deals with a securing device for a photovoltaic panel, such as previously defined.

In addition, the present invention also includes a photovoltaic system including:
a photovoltaic panel, such as previously defined;
an inverter designed to convert the direct current from the panel into alternative current.

According to another possible characteristic, said photovoltaic system includes an electricity meter to measure the quantity of current that is generated by said panel and/or injected into the electric installation.

The invention shall be better understood, and other goals, details, characteristics and advantages shall appear more clearly in the following description of specific embodiments of the invention, which are introduced only for information and non-limitatively, with reference to the appended picture, where:

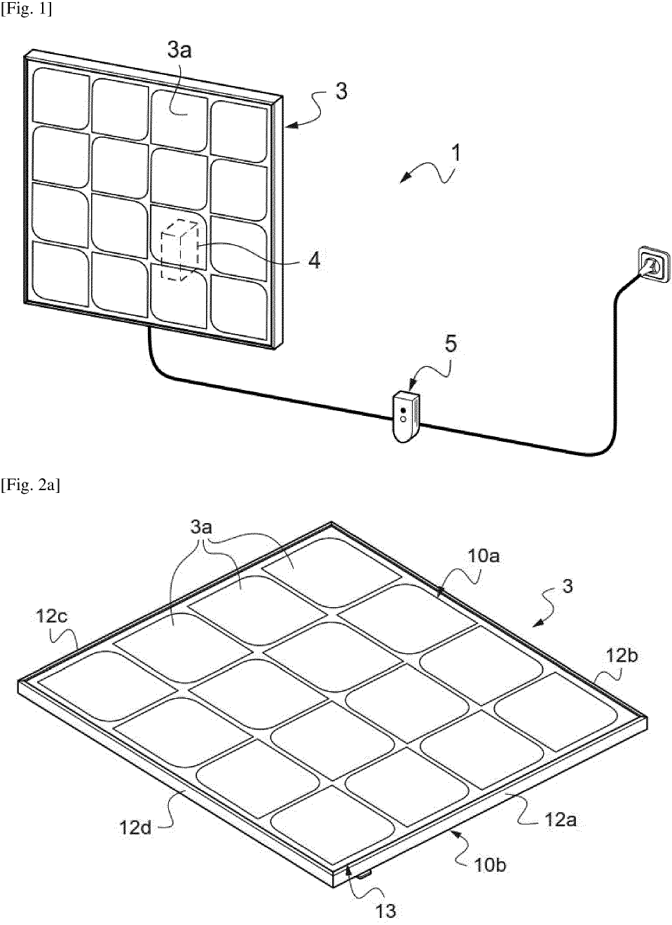

the FIG. 1, referred as [FIG. 1], is a schematic view of a photovoltaic system including a photovoltaic panel according to the invention;

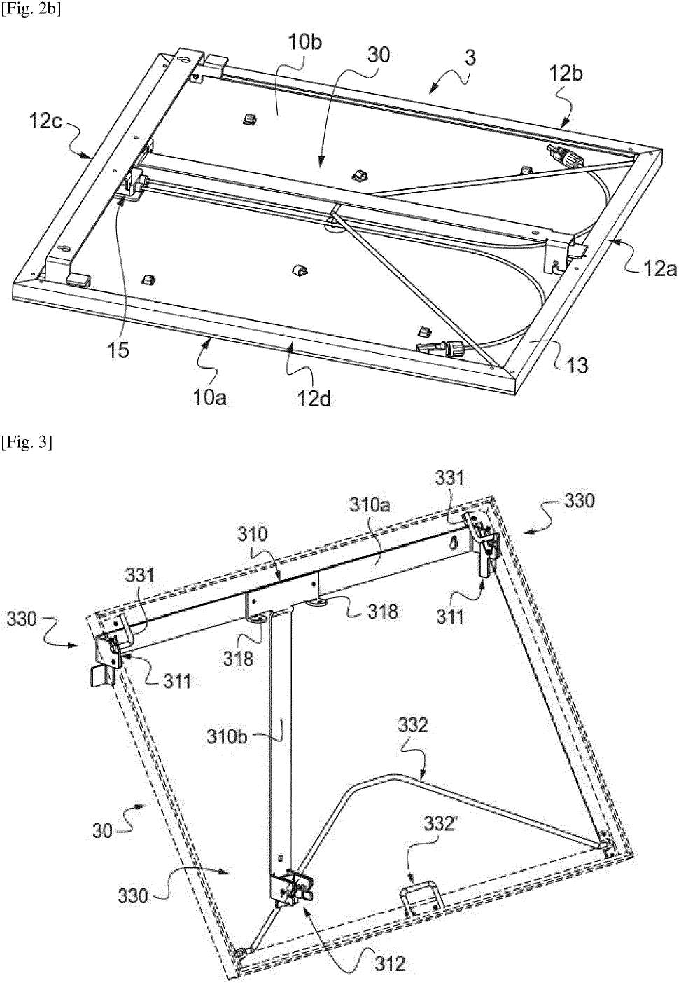

the FIGS. 2a and 2b, respectively referred as [FIG. 2a] and [FIG. 2b], are schematic perspective views of said panels of [FIG. 1];

the FIG. 3, referred as [FIG. 3], is a schematic perspective view of the securing device of the panel of the FIGS. 2a and 2b;

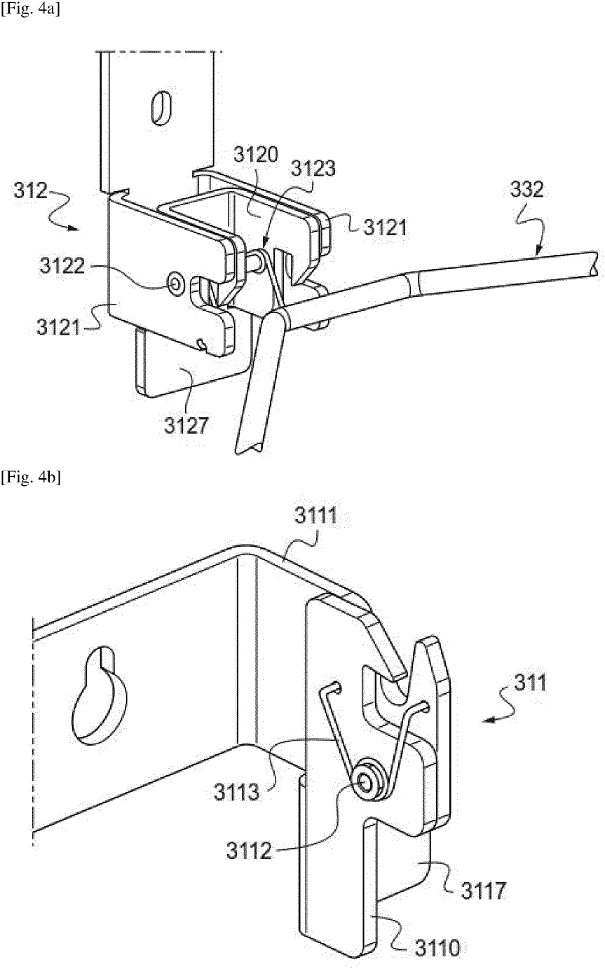

the FIGS. 4a and 4b, respectively referred as [FIG. 4a] and [FIG. 4b], are enlarged views of the female components of the securing device of [FIG. 3];

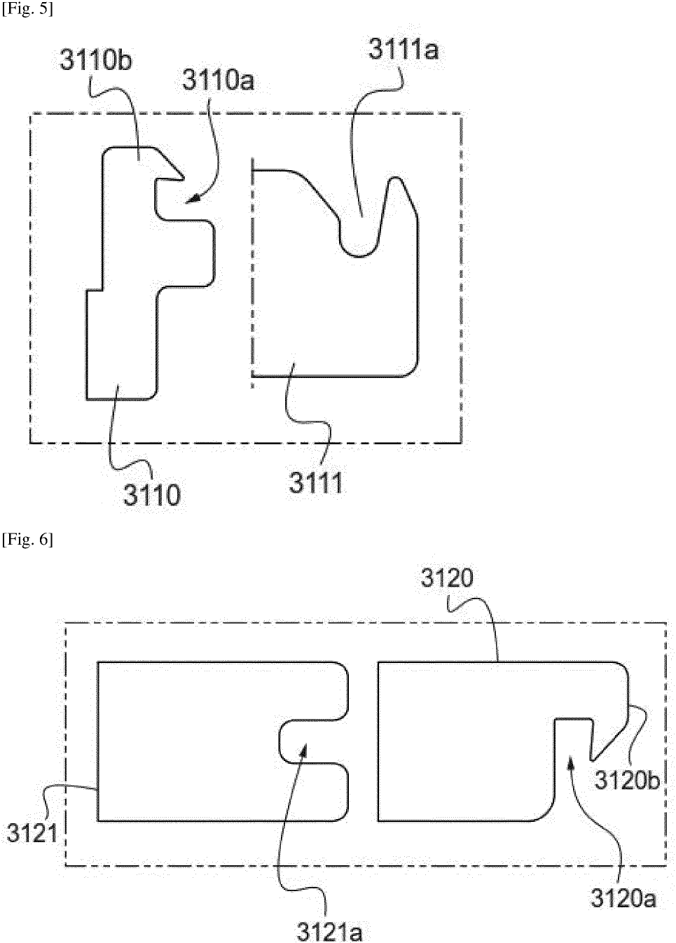

the FIGS. 5 and 6, respectively referred as [FIG. 5] and [FIG. 6], are very schematic sectional views of the female components of the FIGS. 4a and 4b;

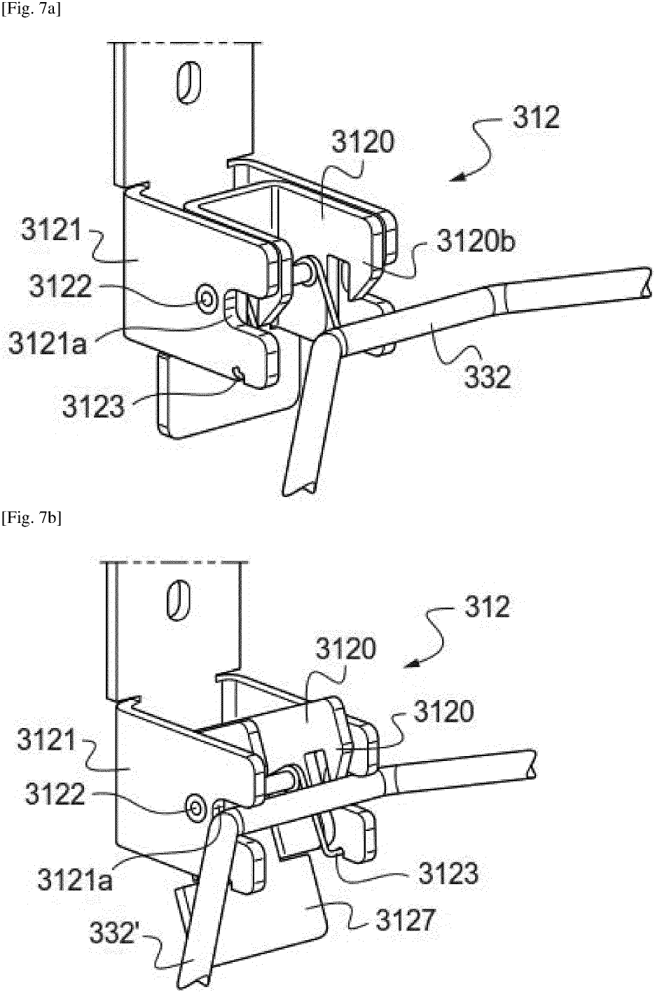

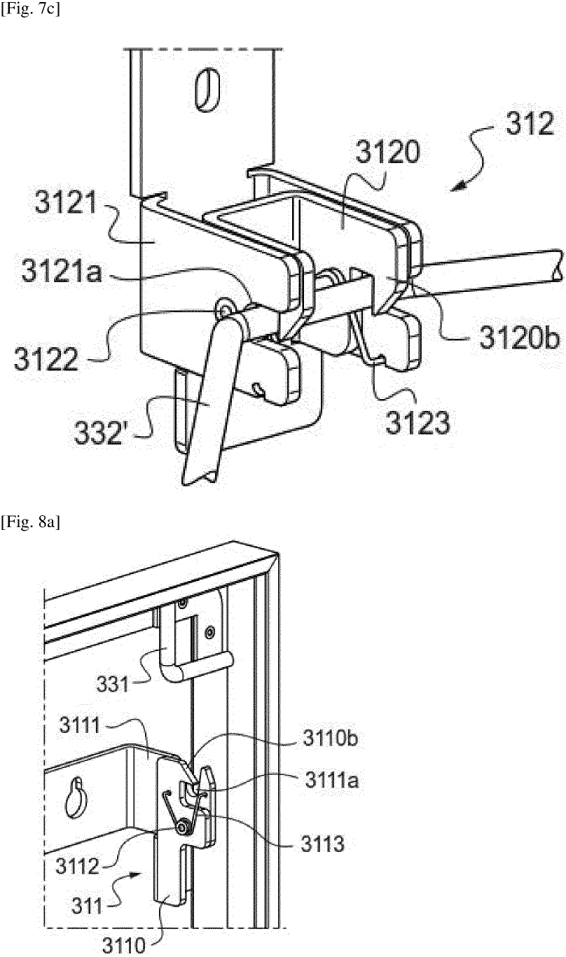

the FIGS. 7a to 7c, respectively referred as [FIG. 7a], [FIG. 7b] and [FIG. 7c], show the insertion of a male component into the female component of [FIG. 4a];

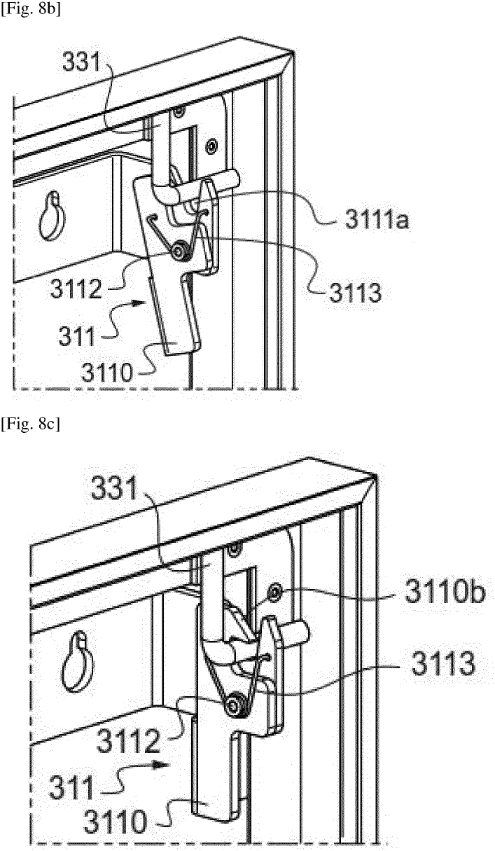

the FIGS. 8a to 8c, respectively referred as [FIG. 8a], [FIG. 8b] and [FIG. 8c], show the insertion of a male component into the female component of [FIG. 4b].

Hence, the FIG. 1, referred as [FIG. 1], very schematically shows a photovoltaic system 1 according to the invention, which includes:
a photovoltaic panel 3 including at least one photovoltaic cell 3a;
an inverter 4 connected to said panel 3 and designed to convert the direct current from the panel 3 into alternative current;
an electricity meter 5 connected to said panel 3 through the inverter 4 and to an electric installation, such as the installation of a house or a commercial building.

Thus, the photovoltaic panel 3 converts solar energy into electricity thanks to said cells 3a, the electricity is received by the inverter 4 and transmitted to the electricity meter 5 before being adequately reinjected into the grid of an installation (such as a household, a plant, etc.).

For example, said electricity meter 5 is able to communicate wirelessly with various electric appliances, so that the user of the panel can know any time how much current the system 1 is generating and/or their level of electric autonomy.

Thus, said photovoltaic panel 3, more particularly illustrated in the FIGS. 2a and 2b, respectively referred as [FIG. 2a] and [FIG. 2b], includes a first and a second main side 10a and 10b connected with each other by lateral sides 12a-d.

On one hand, the photovoltaic cells 3a are mounted in a plane and in a frame 13; on the other hand, they form a first face 10a or front side of the panel 3 that has to be exposed to the sun rays.

As shown in [FIG. 2b], said panel 3 also includes:
a junction box 15 that makes it possible to connect said cells 3 to the inverter 4;
a securing device 30 to fix said panel 3 to a surface.

Said junction box 15 and said securing device 30 are located on the second side 10b of said panel 3, also called back side.

It shall be noted that a surface refers to at least three fulcrums, thanks to which the securing device can lie on a surface, such as a wall, a roof or an adequate mechanical framework, wherein said device 30 is fixed to said surface with at least two fulcrums.

Thus, the securing device 30 includes two parts, more particularly visible at the FIG. 3, referred as [FIG. 3]:
a first part 310 used as a support and designed to be fixed to a surface;
a second part 330 in conjunction with said panel 3.

For example, the fixing of said first part 310 of the device 30 is made through securing means (not figured), such as screws, bolts, etc.

Said first and second parts 310 and 330 are designed to cooperate mechanically, according to a pivot link, to secure said panel 3 to a surface.

In addition, when cooperating mechanically, the first and second parts 310 and 330 are designed to be mechanically locked into one another, so that they cannot untie inadvertently.

The mechanical locking of said parts 310 and 330 notably prevents the translation movement of the parts 310 and 330 relative to one another (or translation lock) without impeding the rotation movement permitted by the pivot link between said parts 310, 330.

It should also be noted that the mechanical cooperation of the first and second parts 310 and 330 is designed to take place without tools by simply inserting one part into the other.

More particularly, said first and second parts 310, 330 respectively include first and second male and/or components, respectively 311, 312 and 331, 332, 332′.

Thus, each of said parts 310, 330 includes male and female parts designed to mechanically cooperate with the component of the complementary kind.

The male and female components, respectively 311, 312 and 331, 332, 332′, can be equally set up on the first and second parts 310, 330. However, in the context of this example of embodiment, the female components 311, 312 are located on the first part 310 while the second part 330 includes the male components 331, 332, 332′.

Here, the first part 310 is a substantially T-shaped piece, but said part 310 can also have other shapes, like a triangle or a Y. The piece that forms the part 310 is generally made of a metallic material, such as aluminum (both lightweight and robust), steel, plastic, etc.

In this case, the substantially T-shaped first part 310 is made of two profiles 310a and 310b secured to one another at the junction of the T. Each end of the T features female components 311, 312. It should also be noted that the first part 310 includes securing features 318, for example at the junction of said T, that allow to secure an inverter (not figured) on said part 310.

The male components 331, 332, 332′ are fixed to the panel 3, for example at the frame 13 of said panel 3. Said male components can be movable or inseparable from the structure of said panel 3. In this case, said male components 331, 332, 332′ are substantially shaped as a curved rod, a handle or a section of a ring, but they may have any shape, as long as it allows some mechanical cooperation with a complementary component (here a female one). It shall be noted that the male components can be made by the “shaped string” process.

There are three kinds of male components:
a first kind 331 is positioned at an end of the panel 3; here, there are two of them at one of the corners of the frame 13;
a second kind 332 is positioned at the opposite end or where are positioned the male components of the first kind 331;
a third kind 332′ is positioned at the same end as the second kind 332 and extends on the width of the panel 3; for example, it is fixed to the panel 3 at the corners of said frame 13.

The female components 311, 312 are particularly shown on the FIGS. 4a and 4b, referred as [FIG. 4a] and [FIG. 4b]. There are two kinds of female components, a first kind 311 at each end of the profile 310a (or of the bar of the T) and a second kind at the base of the T (hence at the free end of the profile 310b).

Thus, each of the female components 311, 312 includes a reception recess 3111a, 3121a, 3110a, 3120a, here notches, but any shape is suitable that makes it possible to receive a protrusion of the male component 331, 332, 332′.

Each of the female components 311, 312 includes:
a support piece 3111, 3121, wherein said support piece is here a part of the profile 310a, 310b that is adjusted or cut in an adequate manner, but it may also be a patch that is fixed to the first part 310;
a movable piece 3110, 3120 (or sub-component) designed to receive a complementary male component and lock, when in position (which means when the male component is inserted or snapped into the reception recess of the female component), the retrieval of the male component from the female component; then, there is an interlock of the first and second parts 310, 330 in one another through said male components 331, 332, 332′ and said female components 311, 312;
an axis 3112, 3122 freely mounted on the support piece 3111, 3121 and on which the movable piece 3110, 3120 is also freely mounted; thus the piece 3110, 3120 can rotate around the axis 3112, 3122;
a restoring means 3113, 3123 such as a spring, that is designed to pull back the movable piece 3110, 3120 to a preset position, wherein said restoring means 3113, 3123 is advantageously mounted on the axis 3112, 3122 and linked (or secured) on the support piece 3121, 3111.

More specifically, for the female component 312, two springs 3123 are freely mounted on the axis 3122, with each spring having two ends, wherein the first one is secured to the support piece 3121 (for example by being inserted into an adequate cavity) and the other one is free and extends toward the support piece 3120, so that when the movable piece 3120 rotates around the axis 3122, this free end touches the support piece 3120 and presses said end. The reaction of the spring 3123 to this compression lead to the return of the movable piece 3120 to its initial position (that blocks the retrieval of the male component from the female component).

Similarly, for the female component 311, there is a spring 3113 that is freely mounted on the axis 3112, wherein each of its ends is respectively secured to the support piece 3111 and to the movable piece 3110 (for example by being inserted into an adequate cavity). The movement of the movable piece 3110 deforms (stretches) the spring 3113 that creates a restoring force on the movable piece 3110, so that it returns to its initial position (that blocks the retrieval of the male component from the female component).

It shall be noted that the axes 3112, 3122 of the various female components 311, 312 are in a plane substantially parallel to the main extension plane of the panel 3.

More particularly, the support piece 3111, 3121 and the movable piece 3110, 3120 include each a reception recess 3111a, 3121a, 3110a, 3120a (here a notch) for the male component 331, 332, 332′. Said notches are more specifically visible at the FIGS. 5 and 6, respectively referred as [FIG. 5] and [FIG. 6].

In addition, the reception recesses 3110a, 3120a of the movable piece 3110, 3120 include an end with the shape of a hook 3110b, 3120b, wherein the hook is turned to their respective notches 3110a, 3120a. The internal surface of said hook 3110b, 3120b serves as a stop for the male component when it is inserted into the notch, which prevents its retrieval.

The FIGS. 7a to 7c, respectively referred as [FIG. 7a], [FIG. 7b] and [FIG. 7c], show the insertion of a male component 332′ (of the third kind) into the female component 312. More specifically, the male component, here with the shape of a handle 332′, is inserted along a substantially linear translation (in an orthogonal plane relative to the main extension of said panel) into the female component 312.

Said handle 332′ touches the external surface of the hook 3120b of the movable piece 3120 (for example an external surface in shape of a bevel profile), which leads to the rotational movement of the movable piece 3310 to allow the insertion of the handle 332′ into the notch 3121a of the support piece 3121. Once in the notch 3121a, the movable piece 3120 is no more stressed by the handle 332′ and the spring 3123 pushes back the movable piece 3120 to a position where the notch 3120a and the hook 3120b enclose the handle 332′. Then, the internal surface of the hook 3120b acts as a stop that blocks the translational retrieval of the handle 332′ from the notches of said support piece 3121 and said movable piece 3120.

It shall be noted that the insertion of the male component of the second kind 332 into the female component 311 is made the same way as the insertion of the male component of the third kind 332′.

The FIGS. 8a to 8c, respectively referred as [FIG. 8a], [FIG. 8b] and [FIG. 8c], show the insertion of the male component 331 into the female component 311.

More specifically, the male component, here with the shape of a curved rod 331, is inserted along a substantially linear translation (in an orthogonal plane relative to the main extension of said panel) into the female component 311.

Said curved rod 331 touches the external surface of the hook 3110b of the movable piece 3110 (wherein the external surface has the shape of a bevel profile), which leads to the rotational movement of the movable piece 3310 to allow the insertion of the handle 332′ into the notch 3111a of the support piece 3111. Once in the notch 3111a, the movable piece 3110 is no more stressed by the rod 332 and the spring 3113 pushes back the movable piece 3110 to a position where the notch 3110a and the hook 3110b enclose a handle 332′. Then, the internal surface of the hook 3110b acts as a stop that blocks the translational retrieval of the handle 332′ from the notches of said support piece 3111 and said movable piece 3110.

Thus, securing the second part 330 to the first part 310 is made the following way:
movement of the panel 3 parallel to the second part 330 (or to the surface on which it is fixed) until insertion of the male components 331 into the components 311 to form a pivot link; thus, the insertion direction is in a plane parallel to the main extension plan of the first part;
blocking or locking of the male components 311 in the female components 331, which prevents the retrieval of said components 311, 331 from each other;
then rotation of the panel 3 according to the pivot link made of the male and female components 311 and 331 in mechanical cooperation, until one of the male components 332 or 332′ inserts into the complementary female component 312 (thus, the final insertion direction of the male component 332 or 332′ is in an orthogonal plane relative to the main extension plane of the first part);
blocking or locking of a male component 332 or 332′ in a female components 312, which prevents the retrieval of said components 312, 332 or 332′ from said female components 311, 312.

It shall be noted that the male component 332′ has a greater extension (that acts as a crutch for the plate) than the male component 332, which yields a greater tilt for the panel 3 relative to the surface to which said panel 3 is secured. The angle between the panel 3 and the surface (thus with the first part 310) is advantageously 30°.

In a non-figured embodiment, the male component 332′ is adjustable lengthwise, for example because it is telescopic, and thus makes it possible to adjust the tilt angle of the panel 3.

It shall also be noted that the first part 310 includes disengagement features 3117, 3127, more particularly visible in the FIGS. 4a, 4b, 7a-c and 8a-c. Said disengagement features 3117, 3127 are generally plane surfaces of a few square centimeters that are connected, fixed or in conjunction with the movable pieces 3110, 3120 of the female components 311, 312, whose tipping causes the rotation of the movable piece 3110, 3120 and unblocking (or unlocking) of the male component 331, 332, 332′ matching the female component 311, 312.

More specifically, the user can push these disengagement features 3117, 3127 to move the movable piece 3110, 3120 to a position where the hook 3110b, 3120b no more blocks the retrieval of the male component from the notch 3110a, 3120a.

Thus, the user can retrieve, easily and without any tool, the part of the panel 3 that includes the photovoltaic cells and the electric connection for maintenance, repair and/or cleaning processes.

In a non-figured embodiment, the female components include a movable piece mounted in a translative manner on a slide inside the fix or support piece. The male component, as previously, inserts itself into the female component and moves the movable part (here in translation) to come and insert into a reception recess in the support component. Then, as previously, the movable piece is pushed back to a locking position by a restoring means (such as a spring) to block (and lock) the position of the male component in the female component.

1. A photovoltaic panel including:
at least one photovoltaic cell capable to convert solar energy into electricity;
a securing device including a first part used as a support and designed to be fixed to a surface, and a second part in conjunction with said panel, wherein said first and second parts are designed to cooperate mechanically, according to a pivot link, to secure said panel (3)-to a surface through said first part, so that, when mechanically cooperating, said first and second parts are designed to have said parts locked in one another, wherein said first and second parts include respectively first and second male and/or female components designed to mechanically cooperate, wherein the second female component include at least one movable sub-component designed to, on one hand, receive a male component and, on the other hand, lock the position of the male component in the female component.
characterized in that said at least one movable sub-component is rotatively mounted thanks to an axis.

2. A panel according to claim 1, characterized in that each female component includes at least a reception recess for a male component.

3. A panel according to claim 2, characterized in that at least one male component is designed so that said panel, through the second part, can switch between two different angular positions relative to the first part .

4. A panel according to claim 1, characterized in that inserting the male components into the female components is made along two different directions that are orthogonal to each other.

5. A panel according to claim 1, wherein said securing device (5)-includes disengagement features to remove the second part from the first part of said device.

6. A securing device for a photovoltaic panel according to claim 1.

7. A photovoltaic system including:
a photovoltaic panel according to claim 1;
an inverter designed to convert the direct current from the panel (3)-into alternative current.
